(19) United States
(12) Patent Application Publication
(10) Pub. No.: US 2023/0347394 A1
(43) Pub. Date: Nov. 2, 2023

(54) DEVICE FOR ACCELERATING DECOMPOSITION OF A DECEASED ANIMAL

(71) Applicant: Lauren Van Wyk, Sully, IA (US)

(72) Inventor: Lauren Van Wyk, Sully, IA (US)

(21) Appl. No.: 18/308,930

(22) Filed: Apr. 28, 2023

Related U.S. Application Data
(60) Provisional application No. 63/337,333, filed on May 2, 2022.

(51) Int. Cl. B09B 3/35

(52) U.S. Cl. CPC B09B 3/35

(57) ABSTRACT

A device for accelerating decomposition of a deceased animal. A bucket comprising a cavity is mounted to a vehicle. A coupler comprising a first end configured to engage the rotor bar and a second end configured to engage a moving element of the vehicle. A rotor is rotatably mounted within the cavity of the bucket, where the rotor comprises a rotor bar having a length and a plurality of shredder blades mounted along the length of the rotor bar. A coupler connects the device to the vehicle, and comprises a first end configured to engage the rotor bar and a second end configured to engage a moving element of the vehicle. The plurality of shredder blades may be staggered across the length of the rotor bar.

### CROSS-REFERENCE TO RELATED APPLICATIONS

This patent application claims priority to U.S. Provisional Patent Application No. 63/337,333 filed on May 2, 2022, the entirety of which is incorporated herein fully by reference.

### FIELD OF THE DISCLOSURE

This disclosure relates generally to a shredding device, and in particular to a device for shredding the carcass of a deceased animal in order to accelerate decomposition, bio digesting, or incineration of the carcass.

### BACKGROUND OF THE DISCLOSURE

Despite a producer's best efforts to maintain animal health, etc., some level of animal mortality still occurs in any livestock or poultry operation. Deceased animals must be disposed of in a timely manner and in accordance with applicable regulations to maintain the health of other animals and the health of the surrounding human population.

Limitations on transporting the animal from the premises where the mortality occurred are contained in the applicable statutes and regulations of the state or other jurisdiction where the operation is located. Acceptable disposal methods typically include burying the carcass, burning or incinerating the carcass, composting the carcass, or having a licensed rendering company 25 remove the carcass. Each disposal method presents its own challenges. Hiring a rendering company to remove a deceased animal can be expensive, and rendering services are not available in some areas; therefore many producers must deal with deceased animals themselves. Burning of carcasses can be time consuming and fuel intensive if an approved incinerator is used. Burying animals can be impractical due to the amount of space required, depth of burying requirements, and winter conditions that prevent digging during much of the year. Decomposition of a whole carcass can be time consuming and possibly attract undesirable scavengers. In some jurisdictions, it is permissible to spread fully composted carcasses on fields, providing valuable nutrients for crops subsequently grown in the fields.

For the reasons stated above, and for other reasons which will become apparent to those skilled in the art upon reading and understanding the specification, there is a need in the art for accelerating the rate of decomposition, bio digesting, or incineration of deceased animals. Thus it is a primary object of the disclosure to provide a portable device for breaking down deceased animals, thus accelerating the rate of decomposition, bio digesting, or incineration of deceased animals.

These and other objects, features, or advantages of the present disclosure will become apparent from the specification and claims.

### BRIEF SUMMARY OF THE DISCLOSURE

The disclosure relates to a device for accelerating the decomposition of deceased animals. In one arrangement, a bucket shaped grinder is attached via hydraulics or power take off (PTO) to a skid steer, wheel loader, or tractor. The bucket of the device comprises a bucket back, a bucket edge, or leading prongs, and opposing bucket ends that form a cavity capable of accepting a deceased animal to be processed by the device. A plurality of structural ribs extend from the bucket edge to the bucket back. A rotor having a plurality of shredder blades mounted on it extends through the plurality of rotor sleeves from one bucket end to the other, and is rotatably mounted such that rotation of the rotor causes the shredder blades to rotate through the deceased animal. Through operation of the device, a deceased animal is reduced to smaller pieces such that decomposition, bio digesting, or incineration of the animal is accelerated. The design of the bucket of the device with bucket ribs and rotor sleeves provides adequate structure and strength to withstand the forces applied by the operating implement and the torque (i.e. resistance to the torque in the process of shredding deceased animals or poultry).

### BRIEF DESCRIPTION OF THE DRAWINGS

FIG. 1 depicts a perspective view of a bucket of a device for accelerating decomposition of a deceased animal according to one embodiment.

FIG. 2 depicts a back view of a bucket of a device for accelerating decomposition of a deceased animal according to one embodiment.

FIG. 3 depicts a top view of a bucket of a device for accelerating decomposition of a deceased animal according to one embodiment.

FIG. 4 depicts a front view of a bucket of a device for accelerating decomposition of a deceased animal according to one embodiment.

FIG. 5 depicts a side view of a bucket of a device for accelerating decomposition of a deceased animal according to one embodiment.

FIG. 6 depicts a perspective view of a rotor sleeve according to one embodiment.

FIG. 7 depicts a side view of a rotor sleeve according to one embodiment.

FIG. 8 depicts a top view of a rotor sleeve according to one embodiment.

FIG. 9 depicts a front view of a rotor sleeve according to one embodiment.

FIG. 10 depicts a top view of a rotor according to one embodiment.

FIG. 11 depicts a perspective view of a rotor according to one embodiment.

FIG. 12 depicts a rotor according to one embodiment.

FIG. 13 depicts a side view of a rotor according to one embodiment.

FIG. 14 depicts a top view of a shredder blade according to one embodiment.

FIG. 15 depicts a shredder blade with a 30 degree offset according to one embodiment.

FIG. 16 depicts a shredder blade with a 45 degree offset according to one embodiment.

FIG. 17 depicts a shredder blade with a 60 degree offset according to one embodiment.

FIG. 18 depicts a shredder blade with a 75 degree offset according to one embodiment.

FIG. 19 depicts a perspective view of a device for accelerating decomposition of a deceased animal according to one embodiment.

FIG. 20 depicts a perspective view of a device for accelerating decomposition of a deceased animal according to one embodiment.

FIG. 21 depicts a perspective view of a device for accelerating decomposition of a deceased animal according to one embodiment.

### DETAILED DESCRIPTION

In the following detailed description of the embodiments, reference is made to the accompanying drawings which form a part hereof, and in which is shown by way of illustration specific preferred embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the present disclosures. The following detailed description is, therefore, not to be taken in a limiting sense, and the scope of the present disclosure is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description, and are not intended to be used as limitations. Accordingly, orientation of an object or a combination of objects may change without departing from the scope of the disclosure.

A device for accelerating decomposition, bio digesting, or incineration of a deceased animal 1 is disclosed. The device for accelerating decomposition of a deceased animal 1 may alternatively be referred to as device 1 or shredder 1 without departing from the scope of the disclosure.

Bucket 100

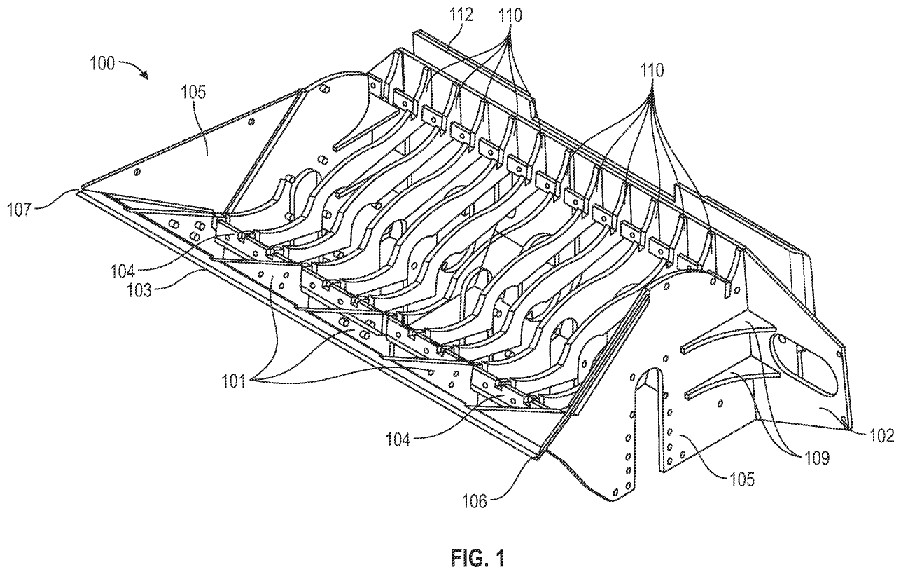

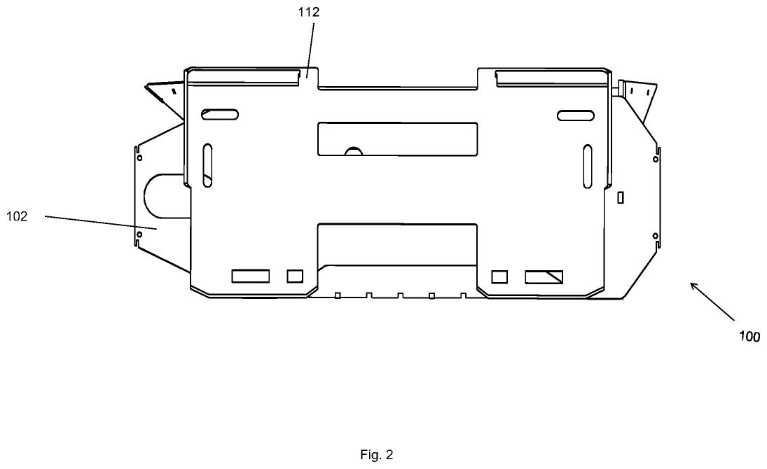

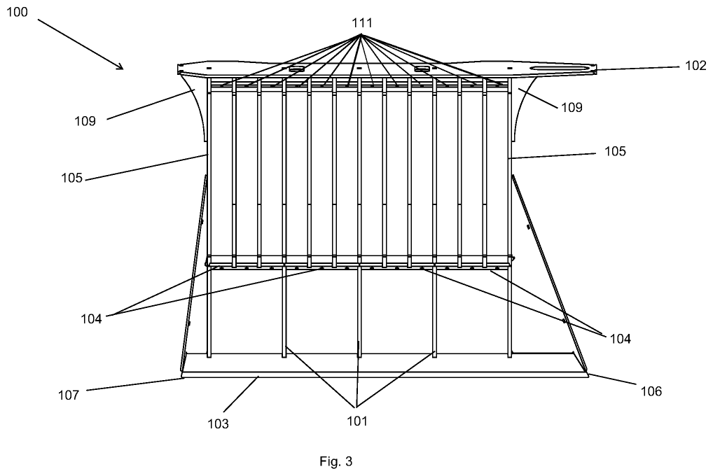

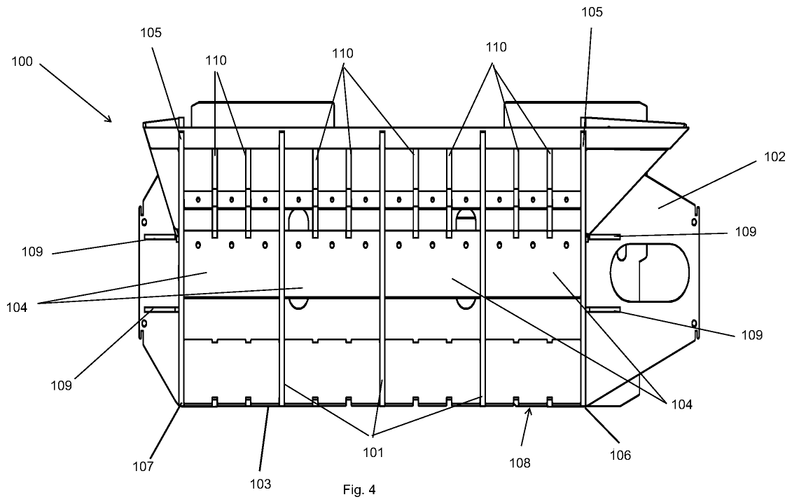

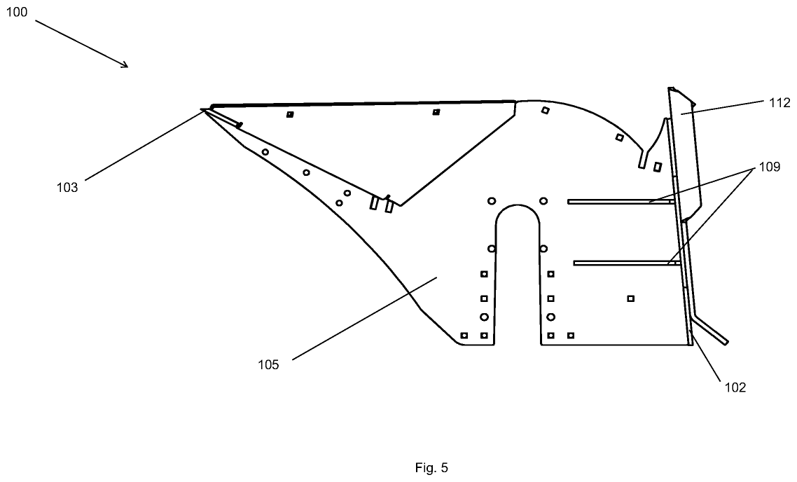

As shown in FIGS. 1, 2, 3, 4, and 5, shredder 1 comprises a bucket 100. Bucket 100 provides structure for mounting and supporting other parts of shredder 1 and also serves as scoop for picking up deceased animals for processing by shredder 1.

Bucket 100 comprises a bucket back 102. In one embodiment, bucket back 102 comprises a generally planar surface. When installed on a skid steer, wheel loader, or tractor, bucket back 102 forms the side of bucket 100 that is closest to the skid steer, wheel loader, or tractor, and one of the flat sides of bucket back 102 faces the skid steer, wheel loader, or tractor. A backplate 112 connects to bucket back 102 and provides a structure for mounting the device 1 to the skid steer, wheel loader, or tractor. Backplate 112 is welded to bucket 100 at all points of contact.

Bucket 100 further comprises a bucket edge 103. Bucket edge 103 forms the leading edge of bucket 100, and bucket edge 103 forms the edge of bucket 100 that is furthest from the skid steer or tractor. In one embodiment, bucket edge 103 comprises a generally planar surface that is mounted at an angle such that a deceased animal may be engaged by bucket edge 103 and scooped into bucket 100. Bucket edge 103 is mounted generally parallel to bucket back 102. Along the bucket edge 103 can be prongs on the leading edge.

Connecting bucket back 102 to bucket edge 103 at the outer ends of bucket 100 are first and second bucket ends 105. A first bucket end 105 connects the bucket left corner 106 located at the left extent of bucket edge 103 to the bucket back 102. A second bucket end 105 connects the bucket right corner 107 located at the right extent of bucket edge 103 to the bucket back 102. Bucket ends 105 are generally perpendicular to bucket back 102 and bucket edge 103. A plurality of gussets 109 connect bucket back 102 to the bucket ends 105. Gussets 109 comprise generally planar surfaces with generally right triangular outlines wherein one edge of each triangle is relatively short and two edges of each triangle are longer. The short edge of each gusset 109 forms one edge of the right angle and connects to bucket back 102. The other edge of each gusset 109 right angle attaches to the adjacent bucket end 105. The remaining edge of the triangle of each gusset 109 may be open or unattached. The plane formed by gusset 109 extends perpendicularly from the flat edges of bucket back 102 and the adjacent bucket end 105. In one embodiment, four gussets 109 are included on each bucket 100 with two gussets 109 on each side; however, other numbers of gussets 109 may be attached to bucket 100 without departing from the scope of the disclosure. A back brace 108 may connect the lower edges of bucket ends 105 and the lower edge of bucket back 102 to provide additional stability for bucket 100. Back brace 108 may comprise a generally rectangular planar surface. Two parallel edges of back brace 108 are approximately the same length as the lower edge of bucket back 102. Back brace 108 is welded to bucket ends 105 and bucket ribs 101 for structural support.

A plurality of bucket ribs 101 extend from bucket edge 103 backward. Bucket ribs 101 are generally equally spaced between bucket left corner 106 and bucket right corner 107, and provide rigidity to bucket edge 103, preventing bucket 100 or bucket edge 103 from deforming under the weight of a deceased animal or pressure applied by the power implement. The bucket ribs 101 and bucket short ribs 110 are continuous from the bucket back 102 over the rotor 1000 to the bucket edge 103 or bucket front anchor 104. The bucket ribs 101 and bucket ends 105 allow the rotor assembly to be removed to the bottom. In one embodiment, each bucket rib 101 comprises a generally planar surface with a generally triangular profile. One edge of each triangle contacts and is attached to the top side of bucket edge 103; thus two corners of each triangle are in contact with the bucket edge 103, and the remaining corner extends up away from the surface of bucket edge 103. One of the remaining edges of each triangle is generally horizontal and the other edge of each triangle is generally vertical. In one embodiment, bucket 100 incudes three bucket ribs 101; however, other numbers of bucket ribs 101 may be used without departing from the scope of the disclosure.

A plurality of bucket front anchors 104 and bucket back anchors 111 may extend between adjacent bucket ribs 101 and between each of the outermost bucket ribs 101 and the adjacent bucket end 105. Bucket front anchors 104 may comprise metal strips that provide additional stability for bucket ribs 101. In one embodiment, one end of a bucket front anchor 104 attaches to a flat side of a bucket rib 101 at or near the generally vertical edge of each bucket rib 101 with the flat surface of each bucket front anchor 104 being generally parallel to the generally vertical edge of the generally triangular shape that forms each bucket rib 101 and where the flat edge of the bucket front anchor 104 extends generally perpendicularly from the flat edge of the bucket rib 101. A plurality of bucket ribs 101 connect bucket edge 103 to bucket front anchors 104, providing additional support for bucket edge 103. Bucket short ribs 110 and bucket ribs 101 may comprise short strips of a rigid material such as metal. In one embodiment, bucket ribs 101 connect each bucket front anchor 104 to bucket edge 103 on the lower side of bucket edge 103 such that the bucket ribs 101 are spaced approximately equally along the length of bucket edge 103; however, other numbers of bucket ribs 101 may be used without departing from the scope of the disclosure. The bucket ribs 101 and bucket short ribs 110 generally protect the rotor 1000 from top impact while providing structural strength to limit distortion and twist of the bucket 100.

Rotor Sleeves 600

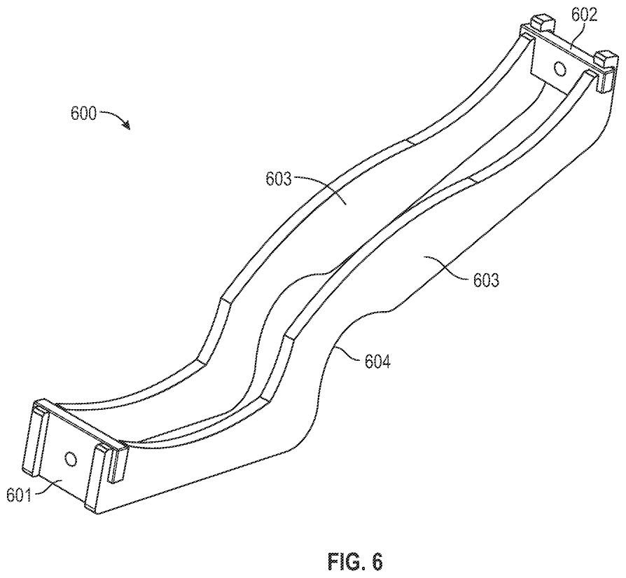

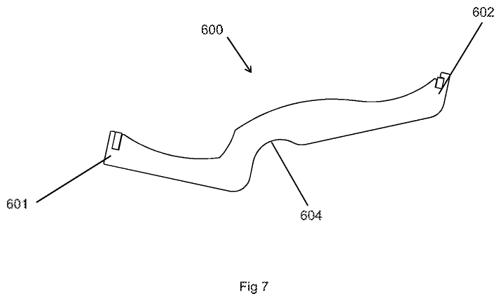

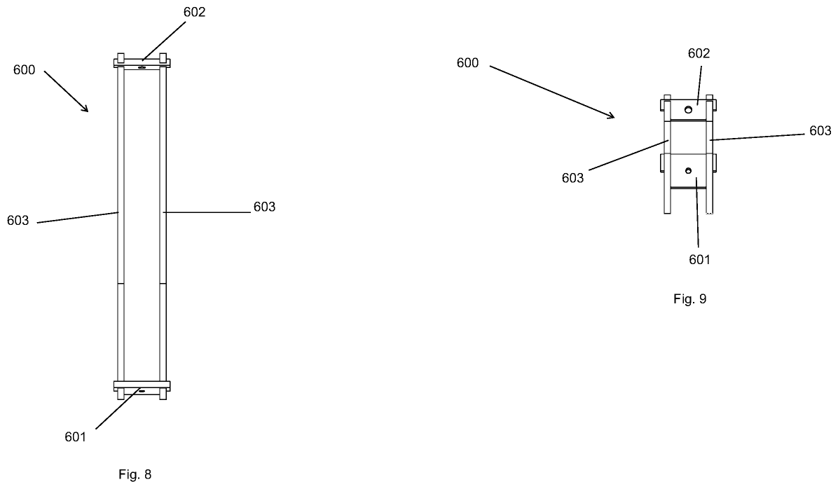

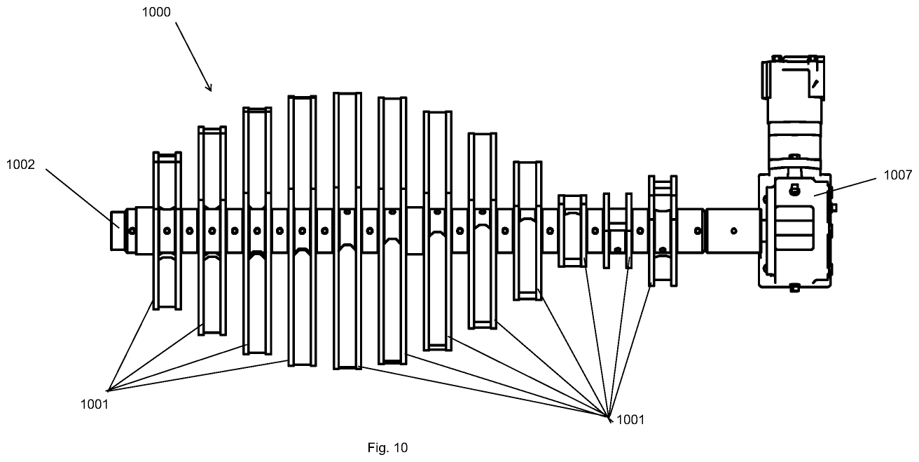

As shown in FIGS. 6, 7, 8, and 9 a plurality of rotor sleeves 600 are inserted into bucket 100 within the cavity formed by bucket front anchor 104, bucket back anchor 111, bucket ends 105, and bucket ribs 101 and bucket short ribs 110. Rotor sleeves 600 provide proper spacing for shredder blades 1001 and provide a replaceable wear component along shredder blade 1001 edges. The materials for the rotor sleeves 600 and shredder blades 1001 should be anti-wear alloys such as AR400 or AR500 being superior than T1 or structural steel. The wear surfaces could be heat treated or hard surfaced with tungsten carbide steel. Each rotor sleeve 600 comprises a front anchor 601, and back anchor 602, and two wear pockets 603. The front anchor 601 and the back anchor 602 of each rotor sleeve 600 are generally parallel to each other and generally perpendicular to the two wear pockets 603. The front anchor 601 is threaded to receive a bolt from the bucket front anchor 104. The back anchor 602 has a hole for bolting to the bucket back anchor 111. The two wear pockets 603 of each rotor sleeve 600 are generally parallel to each other. The back anchor 602 of each rotor sleeve 600 is attached to the bucket back anchor 111. The front anchor 601 of each rotor sleeve 600 is attached to the bucket front anchor 104. Each rotor sleeve 600 may angle generally upward from bucket edge 103 to bucket back 102 with a curve at the approximate center of the length of rotor sleeve 600. Each rotor sleeve 600 may additionally include a notch 604 configured to accommodate the rotor 1000. In one embodiment, twelve rotor sleeves 600 measuring approximately 2.1 inches between the wear pockets 603 may be installed on device 1; however, other numbers of rotor sleeves 600 or spacings of wear pockets 603 may be used without departing from the scope of the disclosure. For example, larger sizes may be needed if device 1 is constructed on a larger scale for larger animals. The width of device 1 and bucket 100 may be scaled to accommodate different sizes of animal or poultry.

Rotor sleeves 600 are thus removable for service or replacement. Rotor sleeves 600 may or may not be present, may be removable or non-removable, welded or not present at all without departing from the scope of the disclosure.

Rotor 1000 and Shredder Blades 1001

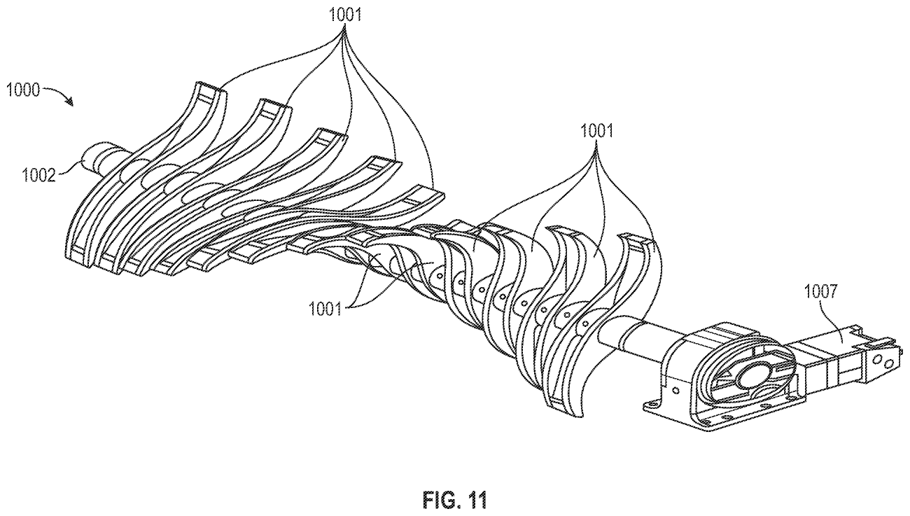

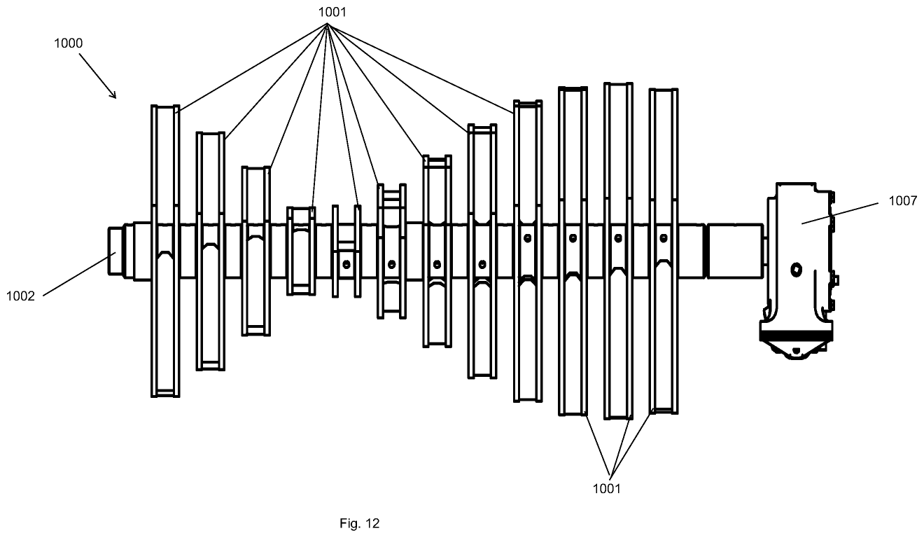

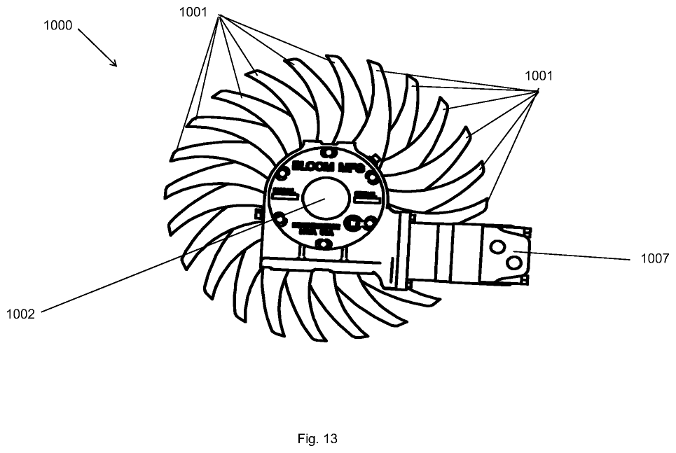

As shown in FIGS. 10, 11, 12, 13, 14, 15, 16, 17, and 18, a rotor 1000 comprises a rotor bar 1002 rotatably mounted within the cavity formed by bucket edge 103, bucket back 102, and bucket ends 105 and a plurality of shredder blades 1001 mounted on the rotor bar 1002. Rotor bar 1002 comprises a generally hexagonal bar that extends from one bucket end 105 to the other passing through each notch 604 formed in the plurality of rotor sleeves 600. Rotor bar 1002 is configured to rotate about an axis that runs along the length of rotor bar 1002; thus causing the plurality of shredder blades 1001 to rotate as the rotor bar 1002 rotates. The hexagonal shape of the rotor bar 1002 and hexagonal interior shape of the shredder blades 1001 can be replaced with a keyed or alternate shape to transfer torque without departing from the scope of the disclosure. The rotor 1000 is configured to operate at a slow RPM, relative to bucket 100 and shredder blade 1001 size. Rotor 1000 generally rotates in one direction during operation of device 1; however, the direction of rotation of rotor 1000 may be reversed, such as when cleaning device 1 or repositioning a deceased animal in the bucket 100.

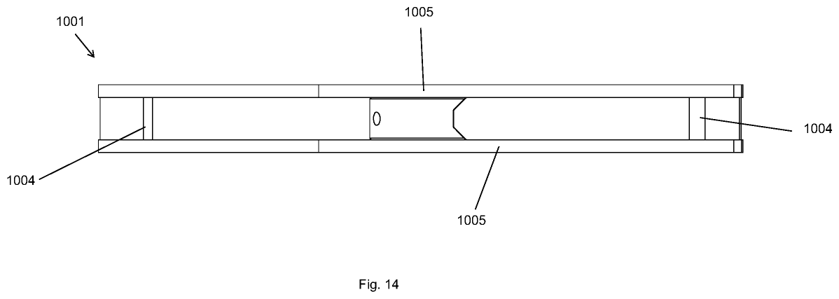

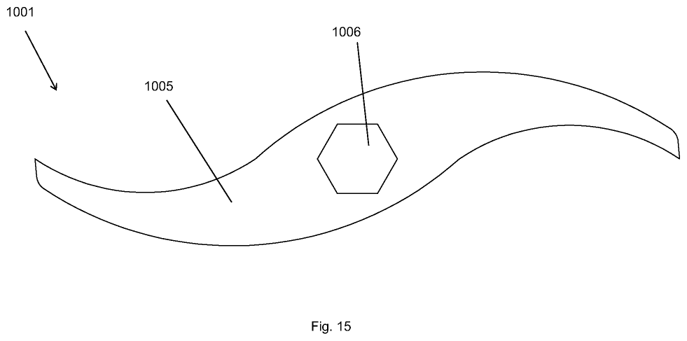

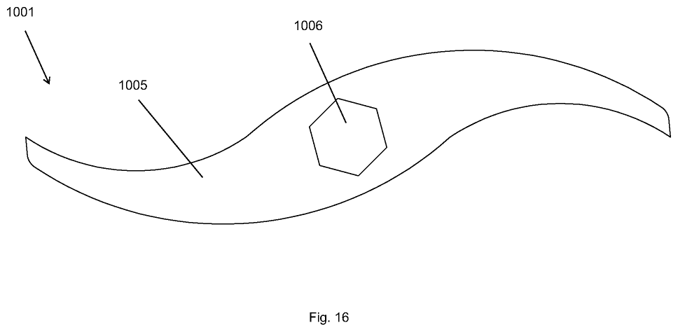

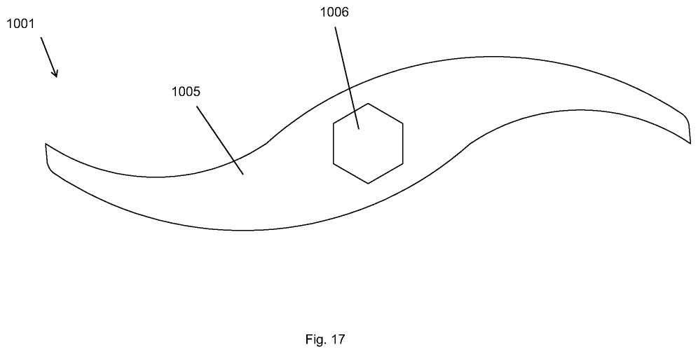

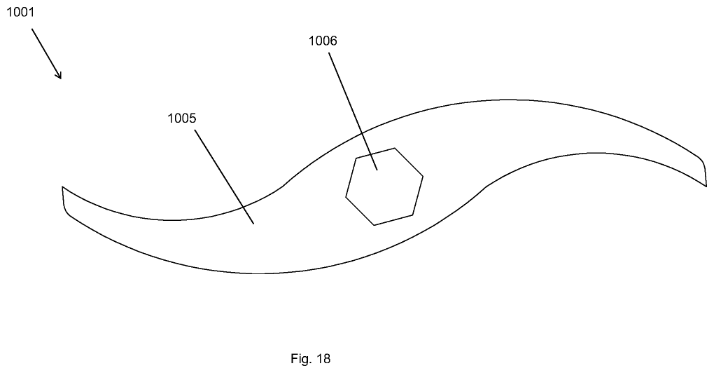

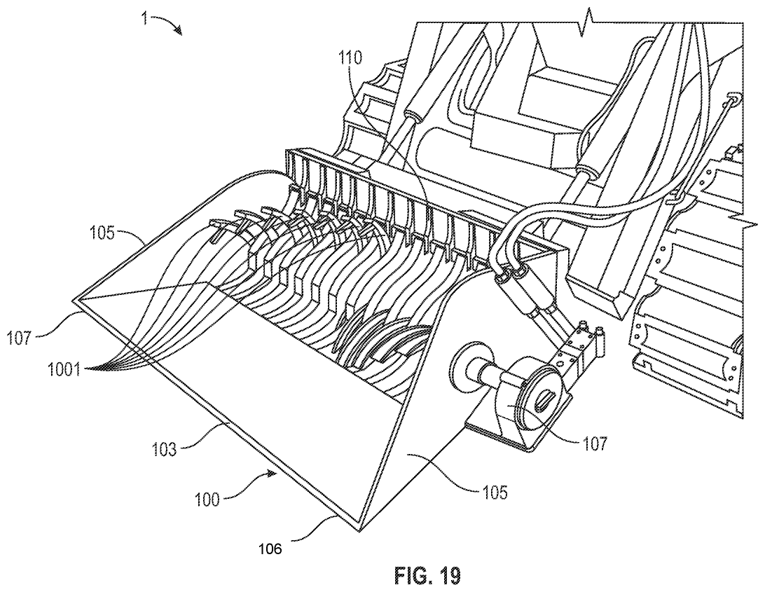

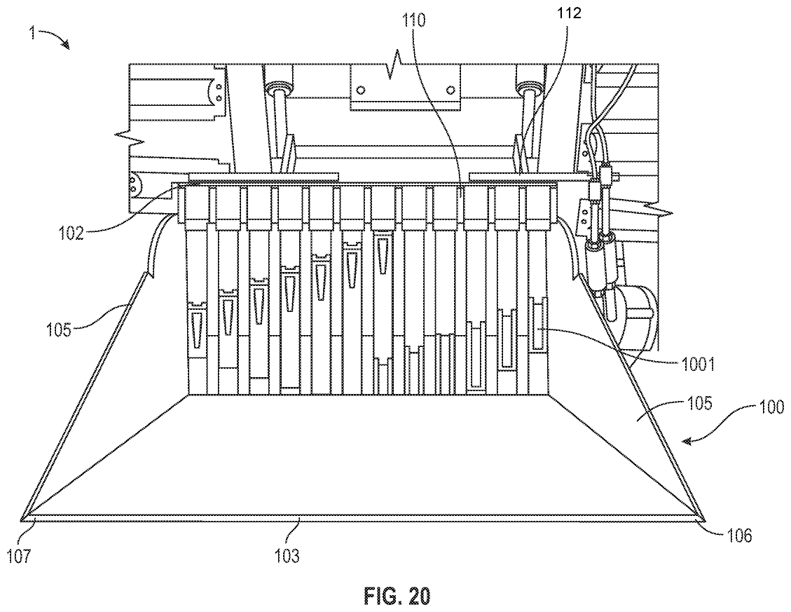

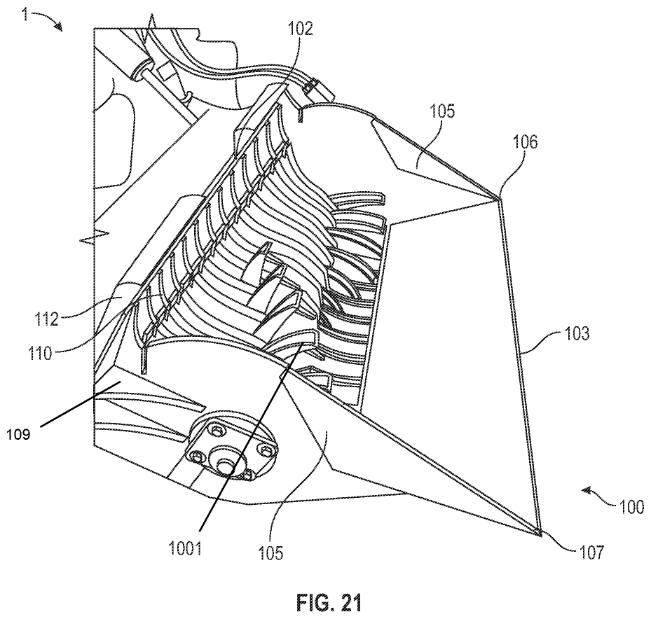

As shown in FIGS. 14, 15, 16, 17, and 18, each shredder blade 1001 comprises first and second shredder blade bars 1004, first and second shredder blade sides 1005, and an opening 1006 defined within first and second shredder blade sides 1005. First and second shredder blade bars 1004 of each shredder blade 1001 are generally parallel to each other and generally perpendicular to the two shredder blade sides 1005. The two shredder blade sides 1005 of each shredder blade 1001 are mounted generally parallel to each other. Each shredder blade side 1005 has two or more concave curves with each concave curve comprising a cutting edge that may be sharpened and may include one or more teeth to improve cutting, shearing, or tearing performance of the shredder blades 1001. When a shredder blade 1001 is in a generally horizontal position, one concave curve is disposed on a first or lower edge of the shredder blade 1001, and the other concave curve is disposed on a second or upper edge of the shredder blade 1001; thus it is always the cutting edge of the concave curve that engages the carcass during operation of the device 1. The concave curve in proper rotation (forward) downward toward the bucket edge 103 has been proven effective for penetrating, grabbing, trapping, and shearing flesh and bone and releases first sized chunks downward below the bucket 100. The upper concave is effective for strength and cleaning obstructions when rotor 1000 is reversed. Straight or convex edges may be used without departing from the scope of the disclosure. Shredder blades 1001 engage and reduce in size a deceased animal being processed by the device 1. A generally hexagonal shaped opening 1006 is formed in the approximate center of each shredder blade side 1005. The hexagonal shape of each opening 1006 may be rotated such that various mounting positions can be achieved when a series of shredder blades 1001 is mounted on the rotor bar 1002. The series of shredder blades 1001 may be mounted in a single or double helix configuration. For example, in one embodiment, the hexagon shape of opening 1006 may be rotated to form four different positions that are 15 degrees apart from each other. In this example, one hexagonal opening 1006 may be positioned at 30 degrees from horizontal as shown in FIG. 15, a second hexagonal opening 1006 may be positioned at 45 degrees from horizontal as shown in FIG. 16, a third hexagonal opening 1006 may be positioned at 60 degrees from horizontal as shown in FIG. 17, and a fourth hexagonal opening 1006 may be positioned at 75 degrees from horizontal as shown in FIG. 18. Multiple sets of shredder blades 1001 may be mounted on rotor bar 1002 by continuing to offset each shredder blade 1001 15 degrees from the adjacent shredder blade 1001 such that the shredder blades 1001 form a complete circle when viewed from the side as in FIG. 13. In one embodiment, twelve shredder blades 1001 measuring approximately 2 inches between the shredder blade sides 1005 may be installed on rotor bar 1002 of device 1; however, other numbers of shredder blades 1001, degrees of difference, sequence of the arrangements, or spacings of shredder blade sides 1005 may be used without departing from the scope of the disclosure. Alternatively, the shredder blades 1001 may be arranged in a different configuration such that performance of device 1 is improved. The width of each shredder blade 1001 may be scaled based on the width of the bucket 100 and the number of shredder blades 1001 desired, where the quantity of shredder blades 1001 is related to the flesh sizing resulting from use of the device 1.

A coupler 1007 connects the rotor bar 1002 of device 1 to a PTO, gearbox, hydraulic system, electric motor, or any combination of these, or other source of rotational motion of the skid steer, tractor, wheel loader, or other vehicle on which device 1 is installed. A first end of the coupler 1007 engages the rotor bar 1002, and a second end of the coupler 1007 engages the PTO, a three point hitch, or other source of rotational motion of the vehicle. Device 1 is a quick attached, fixed or 3-point hitch mounted bucket shaped grinder or shredder that could use a single, double or triple rotor 1000 with properly sized teeth, arms and slots to process carcass into desired sizes. When multiple rotors 1000 are included, each rotor 1000 may be the same size and diameter, or may have different sizes and diameters. Each rotor 1000 may be independently controlled, and each rotor 1000 may rotate in the same direction, or the rotors 1000 may rotate in opposing directions. Each rotor 1000 may rotate at matching or different RPMs. By modifying the diameter of each rotor 1000, the resulting tip speeds of each rotor 1000 may differ. An animal is scooped or placed into bucket 100. The rotor bar 1002 is generally supported at both of its ends by bearings or a drive mechanism, with interim bushing supports to reduce deflection. A structure which protects the rotor bar 1002 yet is designed for servicing the rotor 1000 by removing it from the bottom is desired but not necessary. Operation of the PTO gearbox, hydraulic system, electric motor, combination of these, or other rotational element of the vehicle causes rotor bar 1002 to rotate. Rotation of rotor bar 1002 causes the plurality of shredder blades 1001 to rotate and pass through a deceased animal being held in the bucket 100, causing the deceased animal, including hide, bones, organs, etc., to be reduced to smaller pieces. By reducing the carcass using device 1, surface area is increased, and decomposition, incineration or bio digesting of the deceased animal is accelerated. Because the device 1 is mounted to a skid steer, tractor, or wheel loader, or other vehicle, it can be moved and used where needed.

The device 1 has many benefits and advantages including, but not limited to increasing the surface area exposed to the elements, thus accelerating the rate of decomposition, incineration or bio digesting. The design of a bucket 100 with bucket ribs 101 and rotor sleeves 600 provides adequate structure and strength to withstand the forces applied by the operating implement and the torque (i.e. resistance to the torque in the process of shredding deceased animals). These and other benefits and advantages of the device 1 are apparent from the specification and claims.

### REFERENCE NUMERALS

1—device for accelerating decomposition, incineration or bio digesting of a deceased animal
100—bucket
101—bucket rib
102—bucket back
103—bucket edge
104—bucket front anchor
105—bucket end
106—bucket left corner
107—bucket right corner
108—back brace
109—gusset
110—bucket short rib
111—bucket back anchor
112—backplate
600—rotor sleeve
601—rotor sleeve front end
602—rotor sleeve back end
603—rotor sleeve sides
604—rotor sleeve notch
1000—rotor
1001 shredder blade
1002—rotor bar
1004—shredder blade bars
1005—shredder blade sides
1006—shredder blade opening
1007—coupler

What is claimed:

1. A device for accelerating decomposition, incineration, or bio digesting of a deceased animal comprising:
a bucket comprising a cavity, the bucket configured to be mounted to a vehicle;
a first rotor rotatably mounted within the cavity of the bucket, the first rotor comprising a first rotor bar having a length and a plurality of shredder blades mounted along the length of the first rotor bar; and
a coupler comprising a first end configured to engage the first rotor bar and a second end configured to engage a moving element of the vehicle.

2. The device of claim 1 wherein each shredder blade comprises two plates wherein a first tip of the plates is connected with a first bar and a second tip of the plates is connected with a second bar.

3. The device of claim 2 wherein each shredder blade further comprises a first cutting edge formed in a concave curve near the first tip of the plates and a second cutting edge formed in a concave curve near the second tip of the plates.

4. The device of claim 3 further comprising one or more teeth disposed on each of the first cutting edge and the second cutting edge.

5. The device of claim 2 wherein each shredder blade further comprises an opening formed at the approximate center of the plates

6. The device of claim 5 wherein the opening comprises a generally hexagonal shaped hole.

7. The device of claim 6 wherein the generally hexagonal shaped hole is rotated relative to a horizontal line connecting the first and second tips of the plates among various shredder blades such that the shredder blades can be mounted to the first rotor bar in a staggered configuration.

8. The device of claim 7 wherein the hole of a first shredder blade is mounted in a 30 degree position, the hole of a second shredder blade is mounted in a 45 degree position, the hole of a third shredder blade is mounted in a 60 degree position, and the hole of a fourth shredder blade is mounted in a 75 degree position.

9. The device of claim 8 wherein the first shredder blade, second shredder blade, third shredder blade, and fourth shredder blade are mounted sequentially on the first rotor bar.

10. The device of claim 9 wherein at least one additional set of first shredder blade, second shredder blade, third shredder blade, and fourth shredder blade are mounted sequentially on the first rotor bar such that a series of shredder bars each rotated 15 degrees relative to adjacent shredder bars span the length of the first rotor bar.

11. The device of claim 6 wherein the shredder blades are arranged in a single or double helix configuration.

12. The device of claim 6 wherein the shredder blades are arranged such that performance of the device is improved.

13. The device of claim 1 wherein the bucket has a width that is scalable to animal size.

14. The device of claim 13 wherein each shredder blade has a width that is scalable based on the width of the bucket and a desired flesh sizing.

15. The device of claim 1 wherein the first rotor is configured to operate at a slow RPM.

16. The device of claim 1 wherein the first rotor has an axis of rotation, and wherein the first rotor may be rotated around the axis of rotation in a forward or backward direction.

17. The device of claim 1 further comprising a second rotor rotatably mounted within the cavity of the bucket, the second rotor comprising a second rotor bar having a length and a plurality of shredder blades mounted along the length of the second rotor bar.

18. The device of claim 17 where in the first rotor and the second rotor are independently sized and controlled such that the first rotor and second rotor may operate at matching or different RPMs, directions of rotation, or tip speeds.
